(19) United States
(12) Patent Application Publication
(10) Pub. No.: US 2015/0347978 A1
(43) Pub. Date: Dec. 3, 2015

(54) Systems and Methods for Employer Benefits Compliance

(71) Applicant: Mercer (US) Inc., New York, NY (US)

(72) Inventor: Dawn Tyack, Sutton, MA (US)

(21) Appl. No.: 14/725,272

(22) Filed: May 29, 2015

Related U.S. Application Data
(60) Provisional application No. 62/005,176, filed on May 30, 2014.

(51) Int. Cl. G06Q 10/10

(52) U.S. Cl. CPC G06Q 10/1057

(57) ABSTRACT

A system that ensures an employer's compliance with benefit rules and regulations for a particular period of time based on the employer's strategy and information associated with one or more employees. A compliance engine can generate a projected compliance status for the employer and, if the projected compliance status is of non-compliance, can generate solutions that bring the employer back into compliance optimized to fit the employer's strategy.

This application claims priority to U.S. provisional application 61/005,176 filed May 30, 2014. U.S. provisional application 61/005,176 and all other extrinsic references contained herein are incorporated by reference in their entirety.

### FIELD OF THE INVENTION

The field of the invention is benefits management technologies.

### BACKGROUND

The following description includes information that may be useful in understanding the present invention. It is not an admission that any of the information provided herein is prior art or relevant to the presently claimed invention, or that any publication specifically or implicitly referenced is prior art.

Employers have traditionally provided benefit offerings to their employees, such as medical benefit offerings, as an additional incentive or perk for employees that work for the employer.

Recent regulations have placed a requirement on employers regarding the benefit offerings they provide, the types of benefits they may be required to provide and who they are required to provide it to. For example, section §4980H of the Internal Revenue Code covers the employer shared responsibility provisions (“ESR”) of the Patient Protection and Affordable Care Act (“ACA”) that sets forth certain requirements for employers regarding the health care benefits plans that employers offer their employees.

Others have put forth efforts towards managing employer health care offerings.

For example, the Blue Cross Employee Mandate Calculator (“Blue Cross”) discusses providing information regarding a company's status under the “employer mandate” sections of the Health Care Reform Law. While Blue Cross discusses providing answers about a user's specific business associated with the employer mandate, Blue Cross lacks any discussion about the specific answer information provided to a user, and how these answers are generated. Additionally, Blue Cross lacks any discussion regarding suggestions on adjustments that a user can undertake for compliance, and how any adjustments for compliance fit in with an employer's objectives or strategies.

U.S. published patent application 2009/0216567 to Dust, et al, titled “Insurance System and Method”, published Aug. 27, 2009 discusses employment eligibility for insurance plans, including eligibility based on full-time versus part-time classifications of employees. Dust, however, lacks discussion with regard to an employer's compliance with regard to particular types of benefit offerings.

U.S. Pat. No. 7,330,817 to Exall discusses compliance regarding employment law, and generating checklists for personnel to fill out. In Exall's system, the assessments of compliance and recommendation are made by the human personnel. Additionally, Exall lacks any discussion regarding benefits-based compliance for an employer.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for a system that can determine an employer's compliance status regarding benefits requirements for its employees and generate recommendations harmonizing the employer's benefit offering compliance obligations with an employer's strategic objectives.

### SUMMARY OF THE INVENTION

The present invention provides apparatus, systems, and methods in which an employer can ensure compliance with benefits regulations and laws while adhering to their business strategies.

The system can include a compliance engine executed by one or more computer processors that can receive employee report information for a most recent reporting period about one or more employees, an employee report object for each of the one or more employees, and a strategy object representative of the employer's strategy and determine a projected employee classification for those employees for the duration of a first time period.

The compliance engine can then determine an employer's compliance status for this first time period based on the generated projected employee classifications and employee benefit offering objects representative of the employer's offered benefits to the employees.

In another aspect of the inventive subject matter, the compliance engine can, for situations where an employer is not in compliance, generate a recommendation that brings the employer back into compliance. This can involve modification of one or more employee's work schedules (e.g., amount of hours worked) for a remainder of the first period, adjusting the wages of one or more employees, modifying the benefits offerings for the employees, and modifying the duration of the first time period.

In embodiments, the compliance engine can generate control signals that are transmitted to various employer systems to cause the systems to implement an optimal solution that brings the employer into compliance. For example, the control signal can be one that causes a scheduling system to adjust its schedule for one or more employees such that the hours one or more employees works results in a projected compliance.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 provides an overview of an example system executing functions and processes associated with the inventive subject matter.

FIG. 2 provides a detailed view of an exemplary generation of a projected employee classification.

FIG. 3 provides a detailed view of a variation of the process to generate a projected employer compliance status, implemented according to the requirements of the ESR provisions of the ACA.

FIG. 4 provides an overview of a process of determining full-time equivalents (FTEs) and incorporating the FTEs into the analysis.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

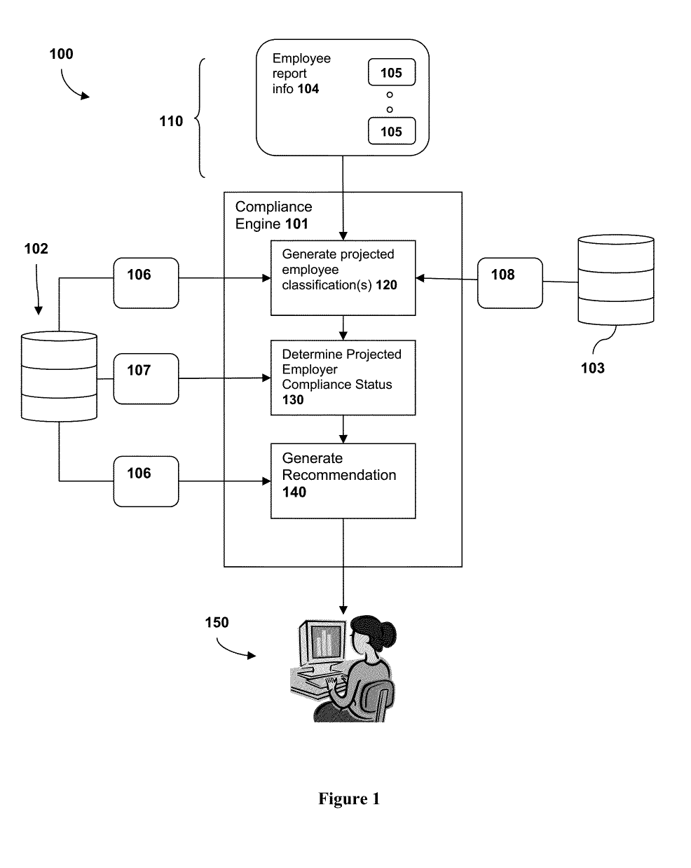

FIG. 1 provides an overview of the execution of functions and processes associated with the inventive subject matter, as applied in an example illustrating ensuring employer compliance with employer-shared responsibility requirements regarding employee benefit offerings for its employees.

In an illustrative example of an implementation, the systems and methods illustrated in FIG. 1 can be applied to analyze an employer's compliance with the ESR provisions of the ACA.

As shown in FIG. 1, the system 100 can include a compliance engine 101 communicatively coupled with an employer strategy database 102 and an employee report database 103.

The compliance engine 101 can be embodied as computer-executable instructions stored on a non-transitory computer-readable storage medium (e.g., hard drive, solid state drive, RAM, flash, ROM, etc.) that, when executed by a computer processor (e.g., ASIC, FPGA, DSP, x86, ARM, ColdFire, GPU, multi-core processors, etc.), cause the processor to carry out functions and processes associated with the inventive subject matter. In embodiments, the compliance engine 101 can be a dedicated processor, specifically hard-coded to carry out functions and processes associated with the inventive subject matter. The compliance engine 101 can be communicatively coupled to the employer strategy database 102 and employee report database 103 via a communication interface that allows for the exchange of data.

The employer strategy database 102 is configured to store employer strategy objects 106 and employee benefit offering objects 107.

Employer strategy objects 106 can be considered to represent strategies or aspects of strategies of an employer. The employer strategy objects 106 can be embodied as data objects stored in the employer strategy database 102. Examples of employer strategies represented by employer strategy objects 106 can include sales strategies (e.g. per particular period of time, such as quarterly, fiscal year, monthly, weekly, calendar year, holiday shopping season, etc.), revenue strategies, employer goal strategies, employment strategies, periodic strategies (e.g., weekly or monthly strategies, which can include strategies to account for periodic or cyclical occurrences), seasonal strategies (e.g., goals and needs related to a particular season such as the Christmas shopping season or a particularly slow sales period of the year), etc.

An employer strategy object 106 can include one or more strategy attributes, representing characteristics or features of a particular employer strategy that can guide or affect the strategy. Examples of strategy attributes include a business goal attribute, an earnings goal attribute, a progress goal attribute, a production goal attribute, an income goal attribute, an expenses goal attribute, an employer structure goal attribute, a projected business needs attribute, a projected employment needs attribute (e.g., for a particular strategy, the employees necessary and the amount of work necessary by one or more employees, can include projected hiring needs), an industry trend attribute, an employee function attribute, a strategy task attribute, etc. Employer strategy objects 106 can also have a time attribute indicating a completion time for the corresponding strategy (e.g., such as time to have the strategy in place, a goal met, a certain progress benchmark achieved, etc.). Other examples of strategy attributes are provided elsewhere in the document.

Employee benefit offering objects 107 can be considered to represent employee benefit offerings provided by the employer (e.g., medical benefits plans, insurance plans, pension plans, etc.) for their employees. The employee benefit offering objects 107 can be embodied as data objects, and can include one or more offering attributes, which can represent characteristics, features, and/or attributes of the employee benefit offering. Some examples of the characteristics represented by the benefit attributes can include a benefit identifier, a benefit provider identifier, an employer contribution, a required employee contribution, and characteristics associated with the coverage and scope of the benefits (e.g., copays, coverage amounts, covered benefits, etc.).

The employee report database 103 is configured to store one or more employee report object 108 for each employee. The employee report object 108 can be embodied as a data object, and can be considered to represent one or more employee reports for the employee for a particular period of time. Examples of employee reports can include timesheets for payroll, performance evaluations, etc., and can represent a period of an employee's time during their employment, such as a two week period, a monthly period, a quarterly period, etc. In embodiments, an employee report object 108 can represent a combination of employee reports, representing a complete “picture” of the employee for the respective time period. Employee report objects 108 can include report attributes, which can correspond to characteristics, attributes and/or features of an employee report. Examples of report attributes can include an employee identifier, an hours worked attribute (representative of the total amount of hours the employee worked for the particular reporting period), an employee job attribute, an employee position attribute, an employee standing attribute (e.g., a derived measurement of an employee's intangibles, such as the value an employee brings to the employer through their work beyond what is traditionally measured through revenue, sales, goals met, etc.), an employee wage attribute, an employee cost attribute (e.g. total cost of the employee to the employer), an employee promotional position attribute (e.g., progress towards a promotion, such as via measured goals, via a time towards eligibility for a promotion, a bargained-for promotion, a union-mandated promotion, etc.), an employee return on investment attribute, an employee revenue attribute (e.g., employer revenue directly attributable to the employee), employee benefits plan attributes (e.g., identifying whether the employee was offered a benefit plan by the employer during for the time period, which benefit plans were offered to the employee, and whether the employee enrolled in a benefit plan, including identifying the plan(s) in which the employee enrolled), etc. In embodiments, the employee report object 108 will preferably include both the employee identifier, the hours worked attribute, and the employee benefit plan attributes, and can include one or more additional report attributes.

In embodiments, the employee report objects 108 represent historical employee reports associated with past reporting periods (i.e., employee reports from previous reporting periods, and can optionally exclude the current reporting period).

In embodiments, the employee report objects 108 can be organized according to a desired time period. This can be according to one or more of the report attributes (e.g., organized according to an employee's promotional cycle as shown by promotional position attributes) or according to a time frame external to the employee report objects. For example, the employee report objects 108 can be organized according to an employer's fiscal calendar, such as a fiscal year or quarters within the fiscal year.

Strategy attributes of employer strategy objects 106 and report attributes of employee report objects 108 can have associations or relationships that can represent the relationship between characteristics of an employer's strategy and the characteristics associated with an employee and/or functions associated with the employee's employment. This relationship can be a cause-and effect relationship, wherein a change in one or more strategy attributes can have a corresponding effect on one or more associated report attributes and vice-versa. The association between attributes can be one-to-one, one-to-many, or many-to-one. In embodiments, the associations between one or more strategy attributes and one or more report attributes can be according to rules that can include weighting factors.

The strategy attributes of employer strategy objects 106, report attributes 105 of the employee report information 104 and those of employee report objects 108, and the offering attributes of employee benefit offering objects 107 can all have values according to the corresponding namespace of each attribute. The attribute value can be indicative of a magnitude, a condition or a state of the characteristic represented by the attribute.

In embodiments, the attributes of an object can belong to a multi-dimensional space, and the corresponding object having the attributes can be represented as a vector or n-tuple within the space.

As illustrated in FIG. 1, the compliance engine 101 receives employee report information 104 for an employee at step 110. The employee report information 104 can include report attributes 105 associated with the most current reporting period. These report attributes 105 can be in the same namespace as the report attributes in one or more of the employee report objects 108, and represent the same characteristics/features/attributes of an employee as corresponding report attributes employee report objects 108.

In the example of FIG. 1, the processes and functions described are performed during a first time period, and prior to the end of the first time period. For example, if the employer wishes to determine a projected compliance by the end of the fiscal year, the processes and functions illustrated in FIG. 1 are performed prior to the end of the fiscal year. Preferably, the analysis is performed sufficiently prior to the end of a first time period such that any corrective action suggested by the compliance engine 101 can be implemented in time to take proper effect.

In embodiments, the first time period can be of an employer-desired length, which can be subject to internal or external regulations or requirements. For example, company policy, regulations or statutory requirements may allow for an employer-desired length having one or more of a minimum length and a maximum length. In other examples, due to internal or external requirements, the first time period may be required to start or end by a certain date or within a certain time period designated by dates.

In the ACA implementation, the first time period can correspond to the standard measurement period, or “look-back” period. In this use case, the first time period can be an employer-designated time period, and can be between 3-12 months. As such, the first time period for the ACA use case can be a time period having an employer-designated start date and a future employer-designated end date, with a length of between 3-12 months.

In embodiments, the employee report information 104 can be information that is not a fully-formed employee report object, as the report attributes 105 can correspond to less than all of the attributes of a complete employee report object. In embodiments, the employee report information 104 can be a employee report object, in the same category or format as one or more of the employee report objects 108 for past reporting periods (such as a report of a periodic, repeating type). In these embodiments, the employee report object corresponding to employee report information 104 can be added to the employee report database 103 after the report attributes 105 are no longer “current” (i.e., when a new reporting period starts and the reporting period to which report attributes 105 apply is no longer the most current) and used as an employee report object 108 in future analysis by the compliance engine 101.

The employee report information 104 can be received via a number of sources. For example, some or all of the report information can be gathered via reporting functions conducting by the employer, such as payroll, periodic evaluations, employee performance reports, employer performance reports (e.g., sales, revenue, expenses, etc. related to the employer, departments within the employer, specific projects, etc.), human resources reporting, and other sources. This information can be collected from one or more databases communicatively coupled with the compliance engine 101, used to receive and store employee information in one or more of these formats and from one or more of these sources. As needed, the compliance engine 101 can be configured to request the employee report information 104 from these sources, or can be configured to receive the information from data sources configured to push the information to the compliance engine 101, such as according to a periodic schedule. In embodiments, some or all of the employee report information can also be manually entered by appropriate employer personnel (e.g., human resources personnel, an employee's supervisor, an evaluator, etc.).

At step 120, the compliance engine 101 generates a projected employee classification for the employee. The projected employee classification can be considered a predicted or anticipated classification of the employee according to an employee classification system or scheme, at the end of a particular time period. For example, the projected employee classification can be the classification of an employee according to a first employee classification, a second employee classification, a third employee classification, and so on. In the example illustrated in FIG. 1, the projected employee classification generated by the compliance engine 101 is the projected employee classification at the end of the first time period (such as the end of the standard measurement period in the ACA use case example), and a first employee classification corresponds to a full-time employee classification whereas a second employee classification corresponds to a non-full-time employee classification.

The projected employee classification can be generated by the compliance engine 101 as a function of one or more employer strategy objects 106 from the employer strategy database 102, one or more employee report objects 108 from the employee report database 103, and the received employee information 104.

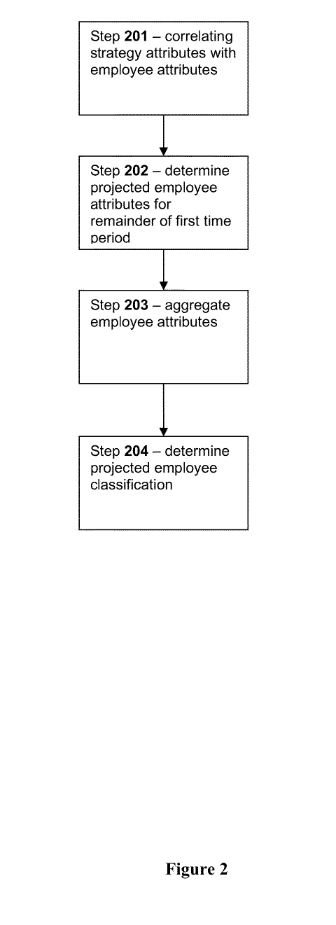

FIG. 2 provides detailed view of an exemplary generation of the projected employee classification in step 120, according to an aspect of the inventive subject matter.

At step 201, the compliance engine 101 correlates one or more strategy attributes from one or more employer strategy objects 106 to associated employee attributes among the employee attributes of employee report objects 108 and employee attributes of the received employee report information 104, for the particular employee, based on the established association or relationship rules of the strategy attributes and employee attributes. In correlating the strategy attributes to the associated employee attributes, the compliance engine 101 determines the employee attribute values for the employee attributes necessary to “meet” the strategy attributes of the strategy object at the end of the first time period.

For example, an employee function strategy attribute can represent an employee function that has to be performed as a part of the employer strategy, including an estimated amount of employee hours necessary to perform the function for the particular strategy. This can be correlated to an employee attribute associated with an hours worked attribute of a corresponding employee or group of employees whose job it is to perform that function.

At step 202, the compliance engine 101 determines projected employee attributes for the employee for the remainder of the first time period, representing a projection of the employee's necessary work to meet the employer goals represented by the employer strategy object. The projected employee attributes for the individual employee can be determined based on the correlated employee attribute values resulting from step 201, as well as other factors associated with the employee and other employees. These factors can include the number of other “equivalent” employees capable of performing a similar function (e.g., such as employees within the same department or project, employees of a same job or position type, same or similar experience, etc.), number of “equivalent” employees who have a previously-scheduled conflict (e.g., scheduled vacation or other time off, etc.), a historical proportion of work load handled/scheduled hours worked by the employee and other “equivalent” employees, an employee hierarchy, union or other negotiated rules regarding amount or length of work, etc.

For example, an employer strategy object for an employer department store can represent a strategy for the big shopping weekend, which can include an operating hours attribute indicating expanded store hours and a staffing attribute indicating anticipated expanded employee manpower needs for the season. The staffing attribute can represent a number of employees needed or an amount of total employee production needed (such as customers helped by hour, sales by hour, etc.). Attributes such as the staffing attribute can be time-dependent, whereby the attribute value can vary according to time periods in the weekend, reflecting anticipated staffing needs for various periods of time during the shopping weekend (e.g., the amount of employees of a particular job or position that must be simultaneously working for a particular period of time to account for customer volume, etc.). One or both of the operating hours attribute and staffing attribute can be associated with the hours worked attributes of groups of employees, such as the cashiers, customer service desk, stock personnel, etc., whereby increases of operating hours attributes and staffing attributes can cause a corresponding increase of an hours worked attribute for the collective group (signifying the collective amount of hours for the particular job or position that is necessary). Based on attributes such as those described above, the compliance engine 101 can determine a projected hours worked attribute for each employee within the group, such as from the collective hours worked attribute for the group.

At step 203, the compliance engine 101 aggregates the employee attributes from the employee report information 104 as well as the employee report objects 108, and the projected employee attributes for the employee determined at step 202, and determines a projected employee classification based on the aggregated employee attributes at step 204.

The projected classification of the employee can be determined according to classification criteria, such as one or more aggregated employee attributes meeting certain value thresholds or falling within particular value ranges. For example, the projected classification of the employee as a full-time employee or a non-full time employee can be based on a threshold total number of hours worked (e.g., actual hours worked until the present and projected hours in the future) by the employee during the first time period. In this example, the compliance engine 101 can determine the projected classification of the employee by aggregating the employee's hours worked attributes from the employee report objects 108 and the employee report information 104 and projected hours worked attributes to result in an aggregated hours worked attribute for the employee. If the aggregated hours worked attribute meets a threshold of hours worked for the employee to qualify as a full-time employee, the compliance engine 101 can assign the projected classification of full-time employee for the particular employee. Conversely, if the aggregated hours worked attribute does not meet the threshold of hours worked, the projected classification for the employee determined by the compliance engine 101 is that of a non-full-time employee.

In the ACA illustrative example, the classification can be provided based on an aggregated hours worked attribute according to each calendar month within the first time period, whereby an employee whose hours worked in any calendar month (either past month, or projected to work in a future month) is at least an average of 30 hours a week and/or 130 hours in the calendar month is classified as a projected full-time employee for the end of the first time period.

In embodiments, the projected employee classification of each employee can be in the form of a projected employee classification object generated by the compliance engine 101, having classification attributes representing the characteristics relevant to the classification and to the determination of an employer's compliance. For example, the classification attributes preferably include a projected classification designation indicating the projected classification for the employee, and can also include classification attributes such as the aggregated hours worked attribute, an employee income attribute (which can be based on the aggregated hours worked for an hourly employee or other employee whose pay is directly related to time worked or results of their work), an employee household income attribute, etc. Information included in or used in generating classification attributes (e.g., employee wage to calculate the employee income attribute, employee household income for the corresponding attribute, etc.) can be obtained by the compliance engine 101 from sources such as employer human resources databases, manual entry by a human resources or other employer official, and/or can be obtained from one or more of the employee report objects 108, the employee report information 104, etc.

In the example illustrated in FIG. 2, the one or more employer strategy objects 106 are assumed to have a corresponding time attribute coinciding with the end of the first time period. In other words, the strategy attributes of the employer strategy objects all have values corresponding to the desired state of the employer's strategy at the time the first period ends. However, if the time attribute of one or more of the employer strategy objects 106 does not coincide with the end of the first time period, the compliance engine 101 can be configured to scale the strategy attributes such that they represent the expected strategy attributes for the state of the strategy at the end of the first time period.

It should be noted that steps 201, 202, 203 and 204 can be updated periodically, such as daily, weekly or bi-weekly, as over time both the employee attributes and strategy attributes can change based on the actual time an employee has worked (e.g., the hours worked attribute is adjusted to account for the actual hours worked as the employee works them) as well as shifts in strategy by the organization (e.g., as work gets completed, the estimated hours needed can drop accordingly). Correspondingly, the aggregation of step 203 can be repeatedly performed to ensure incorporation of current data and the projected employee classification at step 204 re-calculated to account for the updates in data.

The processes of step 120 can be repeated for a plurality of (up to and including all) employees employed by an employer, so as to generate projected classifications for a group of the employees. In embodiments, the compliance engine 101 can be configured to repeat the process of step 120 for additional employees until a particular threshold is met. For example, the compliance engine 101 can be configured to repeat the process of step 120 for each employee until a particular threshold (either as an absolute number of employees or as a percentage of all employees) of full-time or non-full-time employees is met or cannot be met.

At step 130, the compliance engine 101 uses the generated projected employee classifications and one or more employee benefit offering objects to determine a projected employer compliance status. The projected employer compliance status can be considered to represent a prediction of whether the employer will be in compliance with a particular benefits-related law, rule, regulation, norm, standard, etc., at the end of a particular time period. In the example of FIG. 1, the projected employer compliance status represents whether the employer is projected to be in compliance with the employer-provided benefit offering requirements at the end of the first time period, with respect to the employee and the one or more benefit offerings represented by the one or more employee benefit offering objects used in generating the projected compliance status. In embodiments, the projected employer compliance status determined by the compliance engine 101 includes “compliant” and “non-compliant” statuses. In embodiments, statuses representing additional degrees of compliance can be included for situations where compliance to various degrees can have differing outcomes with regard to consequences (e.g. penalties and/or incentives).

In embodiments, the compliance engine 101 can determine a projected compliance status by applying the projected classification of each employee to one or more offering attributes of one or more employee benefit offering objects 107. To do so, the compliance engine 101 can map employee information relevant to the employee's projected classification and compliance to similarly relevant offering attributes of the employee benefit offering objects 107. In embodiments where the projected classification is in the form of a projected classification object, the classification attributes can be mapped to corresponding offering attributes. In other embodiments, necessary information (e.g., an employee's wage, projected employee income by the end of the first time period, etc.), can be gathered by the compliance engine 101 from sources such as employer human resources databases and manual entry by appropriate employer personnel (e.g., HR, supervisors, company officers, etc.). The employer's projected compliance status for that employee can then be determined by the compliance engine 101 by applying the compliance rules to the classification attributes and the offering attributes. In embodiments, the projected compliance status can be applied only to those employees whose projected classification is relevant to an employer's compliance. For example, the projected compliance status can be applied to only those employees whose projected classification is that of “full-time employee.”

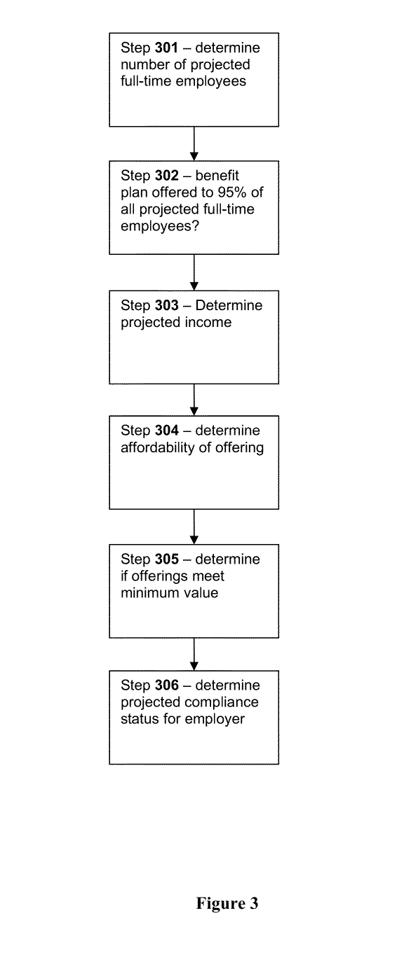

In the ACA example, the projected employer compliance status can represent whether the employer is projected to be in compliance with the ESR provisions of the ACA. FIG. 3 illustrates a detailed overview of a variation of step 130, wherein the compliance engine 101 determines the projected employer compliance status for the employer under the ESR provisions of the ACA. To ensure compliance, the coverage provided by the employer-provided benefit offerings must be affordable and must provide a minimum value.

At step 301, prior to determining projected compliance status for each projected full-time employee, the compliance engine 101 aggregates all employees whose projected classification is of a full-time employee for each month of the first time period. If the aggregated number of projected full-time employees is less than 50 for all months within the first time period, the compliance engine 101 can is configured to output a projected compliance status indicating that §4980H of the ACA does not apply to the employer. If the first time period is less than a calendar year, the compliance engine 101 can perform the determination extending prior to the beginning of the first time period, such that by the end of the first time period, the determination of projected full-time employees will be for a full calendar year prior to the end of the first time period. In embodiments, the compliance engine 101 can proceed to determine the number of projected “full-time equivalent” (FTE) employees based on the employees that whose projected classification is that of non-full-time employees. The FTE determination of these embodiments is described in additional detail below. In these embodiments, the compliance engine 101 is configured to aggregate the total number of projected full-time employees and projected FTEs, and if the number is less than 50, output an indication that §4980H of the ACA does not apply to the employer.

At step 302, the compliance engine 101 then determines, for each projected full-time employee, whether the employee has been provided an employer-provided benefit offering based on the employee benefit plan attributes of the employee report objects 108 for that employee for the months in which the employee qualified as a full-time employee. The determination can also include an assessment of whether the employee currently has employer-provided benefit offerings available to them, based on employee benefit plan attributes 105 of the employee report information 104. Based on this determination, the compliance engine 101 evaluates whether 95% of the projected full-time employees has been offered a benefit plan. If not, the compliance engine 101 stores this determination for inclusion into the ultimate projected compliance status, whereby the employer would be projected to be non-compliant.

For each of the projected full-time employees, the compliance engine 101 determines a projected income. In embodiments, the projected income can be determined based on the aggregate hours work attribute and the employee's wage attributes, wherein the projected income represents the expected income by the employee for the duration of the first time period. The employee's wage attributes can include the employee wage attributes from the employee report objects 108 applicable for the first time period, and can include projected employee wage attributes for the remainder of the first time period. The projected employee wage attributes can be derived from information such as the employee promotional position attributes and internal employer HR information that indicates when the employee may be eligible for a promotion, a bonus, or other type of wage adjustment. In embodiments, the projected income can be considered to be a projected amount of W-2 wages for the taxable year that includes the first time period. In embodiments, the projected income can include W-2 information for the previous taxable year, such as when the first time period overlaps more than one tax year. The compliance engine 101 also determines if the projected income for the employee will exceed 400% of the federal poverty level. If so, the employer is not projected to be subject to any shared responsibility penalties for that employee and is considered compliant for that employee. This determination is performed for each projected full-time employee.

Having the projected income for the employee, the compliance engine 101 can determine whether the benefit offerings represented by the one or more benefit offering objects 107 are “affordable” under the ESR provisions of the ACA by calculating the employees projected maximum allowed contribution based on the projected income at step 304. The maximum allowed contribution can be considered to be the maximum amount of an employee's contribution as a percentage of the total projected income. In 2014, the benefit offering is considered “affordable” under the ACA if the employee's contribution does not exceed 9.5 percent of the employee's household income for the taxable year. This percentage is a statutory percentage, and is subject to adjustment by the government after 2014.

Having calculated a maximum allowed contribution for the employee, the compliance engine 101 maps this calculated amount to the required contribution attribute of each of the benefit offering objects 107 for comparison. In embodiments, the required contribution attribute for each benefit offering object 107 can be a projected required contribution attribute reflecting a projected contribution for a time period beyond the first time period. If the future required contributions for a particular benefit plan have been determined by the benefit provider, required contribution attribute for the benefit offering object 107 can be updated according to the provider-established contributions. Otherwise, the projected required contribution attribute can be determined based on current required contributions and historical contributions, via a trend analysis to project a change in required contributions based on historical changes to the required contributions over time.

In embodiments, the comparison can be performed with the required contribution attribute of the benefit offering object whose contribution is the lowest of all available plans for the particular employee. For any projected full-time employee whose required contribution for all compared benefit offerings available to the employee exceeds 9.5% of the employees projected income, the compliance engine 101 determines that the benefit offerings are not considered affordable under the ESR provisions of the ACA.

To be considered as providing minimum value under the ACA, the employer-sponsored benefit plans offered to employees must cover at least 60% of allowed costs. To determine whether a benefit plan provides the required minimum value, the compliance engine 101 can be configured to incorporate a minimum value calculator such as the one developed by the Department of Health and Human Services (HHS) at step 305. The compliance engine 101 can input the values of one or more offering objects of the employee benefit offering object 107 into the minimum value calculator to calculate whether the benefit plan represented by the offering object 107 meets the minimum value requirement of the ACA.

At step 306, the compliance engine 101 determines a projected compliance status as “compliant” or “non-compliant” for the employer based on the results of steps 301-305. The employer is projected to be compliant by the compliance engine 101 if:
The employer is projected to have less than 50 full-time employees by the end of the first period; or
If a benefit plan is offered to at least 95% of the projected full-time employees and all projected full-time employees are projected to have a household income exceeding 400% of the poverty line; or
If a benefit plan is offered to at least 95% of the projected full-time employees, the projected required employee contribution for self-only coverage does not exceed 9.5% of the employee's projected income (i.e., is “affordable”), and the benefit plan pay at least 60% of the total benefit costs (i.e., provides “minimum value”).

In embodiments, the determination of the projected employer compliance status performed at step 130 illustrated in FIG. 1 (as well as the ACA/ESR implementation illustrated by FIG. 3) can include an analysis by the compliance engine 101 to determine whether any of the factors contributing to the projected compliance status are within a margin of error or a percentage of a threshold that can affect the confidence of the projected compliance status. For any of these factors falling within this margin of error, the compliance engine 101 can flag these factors along with the projected compliance status, to bring them to the employer's attention. In embodiments, the compliance engine 101 can calculate secondary projected compliance statuses that provide adjusted projections of compliance if the projected factors within this margin of error do not carry out according to the “primary” projections. In embodiments, the compliance engine 101 can be configured to account for these “borderline” factors by determining the projected compliance status based on a conservative analysis, according to a “worst case” scenario for each of the borderline factors.

For example, if an employee's projected hours worked is projected to be within a certain percentage of the threshold for full-time employee classification, but just under the threshold to qualify for full-time employee classification by the end of the first time period, the compliance engine 101 can flag this employee as a ‘borderline’ case wherein a slight variation in hours could result in the employee crossing the threshold. The compliance engine 101 can additionally (or alternatively) calculate a projected compliance status by classifying the employee as a projected full-time employee and present the projected compliance status as a secondary status, or as a modified primary compliance status.

In embodiments, the determination of a projected compliance status of step 130 can include, for a determined “non-compliant” status, a calculated projected cost of non-compliance.

The projected cost of non-compliance can include at least one of penalties associated with non-compliance and a projected cost of bringing the employer into compliance.

The penalties associated with non-compliance can include statutory fines, tax implications, costs associated with legal work associated with defending and “fixing” the non-compliance, etc. For example, under the ACA/ESR scenario, the costs of non-compliance can include the statutory fines applicable to non-compliant employers.

The projected cost of bringing the employer into compliance can be based on one or more generated scenarios that bring the employer into compliance and the cost associated with each scenarios. The scenarios can be based on the reason(s) for non-compliance, and each scenario for compliance can be generated according to factors that contribute to the reason for non-compliance. The scenarios can be generated by the compliance engine 101 by using one or more of the employer strategy objects 106, the employee report objects 108 and the employee information 104 (and any projected attribute values for one or more of their attributes), and the benefit offering objects 107 (and any projected offering attribute values) used in the determination of the projected compliance status for the employer.

For example, one or more scenarios can involve bringing the employer into compliance by reducing the projected hours worked (via a reduction of future hours worked until the end of the first period) of one or more employees currently projected as full-time employees such that the one or more employees would no longer project as full-time employees. Under one scenario, this can be so that the total number of full-time employees is less than 50. In another scenario, this can be done for the employees for whom no benefit coverage is offered (to bring the employer into compliance with the 95% requirement of the ACA/ESR, for example), or for whom the offered coverage would be unaffordable according to the projected contribution attribute of the plan and the employee's projected income.

Since the projected hours worked for employees for the first time period can be based at least in part on the strategy attributes of one or more employer strategy objects 106, a modification to the projected hours worked attribute for an employee can also result in a corresponding change in one or more of the strategy attributes. Revisiting the example of the strategy object representing a store's strategy for a big shopping weekend, the strategy object can also include a projected revenue attribute representing the store's anticipated revenue for the shopping weekend, based on an anticipated amount of customers coming into the store. The staffing attribute can similarly be based on anticipated customer traffic, as anticipated for different times during the weekend. A reduction in manpower correlates to a decline in ability to help and check-out customers, which in turn results in lower sales numbers for the store (e.g., less volume processed overall during store hours, customers get tired of waiting in line and leave, don't come into the store when they see long lines, etc.). Thus, in this example, the compliance engine 101 can calculate the cost of bringing the employer into compliance via a reduction the number of projected employee hours worked based on the correlation between the projected hours worked attribute, the staffing attribute and the projected revenue attribute. In this example, cost to bring the employer to compliance can be considered to be the decrease in the projected revenue attribute based on the employee's reduced projected hours worked (or the decrease in the staffing attribute correlated to the projected hours worked attribute). In embodiments, this cost can be offset to a degree by taking into account an employee's wage attribute and/or projected income for the reduced hours and any other employee attributes corresponding to an employee's costs to an employer.

In a further variation of this example, the compliance engine 101 can balance a decrease of the projected hours of one or more employees (for example, more junior or less experienced employees) with an increase of the projected hours of one or more employees (senior or more experienced employees performing the same job), such that the effect on the manpower capacity of the store (and as such, the staffing attribute) is minimized. This balance can be performed a statistical analysis or other optimization technique, and can consider changes in hours worked for each employee, their individual capacity to work (reflected in a capacity attribute or other performance-related attribute), their respective wage attributes, and corresponding the total change in the staffing attribute and ultimately, the projected income attribute of the strategy object caused by changes in each employee's hours worked.

Other examples of scenarios that can be used to bring the employer back into compliance having corresponding costs can include modifying one or more benefit offerings such that their offering attributes meet the requirements for compliance (e.g., such that, in the ACA/ESR example, the benefit offerings are both affordable and of minimum value), obtaining new benefit offerings that bring the employer into compliance, increasing the employer's contribution such that the employee's contributions are reduced into compliance, giving one or more employees a raise such that their income is sufficient to pay the contributions in compliance, etc.

In embodiments, the compliance engine 101 can perform iterative analysis of hypothetical scenarios using input data that would bring the employer back into compliance by modifying one or more of the input conditions (e.g. the employee attributes and/or strategy attributes) for one or more employees and/or for one or more of an increase in employee's contributions, increase in employee's incomes, obtaining complaint benefit offerings, etc. Then the solution that provides compliance while remaining closest with the employer's strategy object can be selected as the optimal solution for the generation of a recommendation at step 140.

At step 140, the compliance engine 101 can generate a recommendation as a function of the determined projected employer compliance status and one or more employer strategy objects 106. The recommendation can include one or more recommended actions for the employer to undertake based on a balancing of the projected employer compliance status and the employer strategy or strategies represented by the one or more employer strategy objects 106.

The recommendation can include a recommendation of actions to undertake by the employer based on the outcome of the scenarios conducted in step 130 and the strategies represented by one or more employer strategy objects. In one example, the recommendation can include actions performed in the scenario that resulted to be the most economically beneficial to the employer, in accordance with a strategy object representing a strategy of maximizing the employer's profits. In another example, for a strategy object representing non-economic performance strategy having non-economic performance goals, the recommendation can include recommended actions for the employer to take that maximize performance by the employees. In embodiments, the objectives and goals of various strategies represented by strategy objects can be considered simultaneously and balanced by the compliance engine 101, so that the recommendation reflects a consideration of a plurality of simultaneous strategies at play for an employer that may have individual, even divergent strategy objectives or goals.

The actions in the recommendation can include one or more of a modification associated with one or more employees, a modification associated with a benefit offering, and a modification associated with an employer strategy.

Examples of actions associated with one or more employees can include a recommended work schedule (including adjustments from presently projected future schedules) for one or more employees for the remainder of the first time period, recommended changes in wages for one or more employees, changes in employer contributions to benefit plans for one or more employees, offer a (compliant) benefit plan to projected full-time employees that currently are not offered one, terminating one or more employees, changing an employee from non-hourly to hourly or vice-versa, providing bonuses to one or more employees, etc.

The recommendation can include recommended adjustments to one or more benefit offerings represented by the one or more benefit offering objects 107 used in the analysis. Additional examples of actions associated with one or more benefit offerings can include adding a benefit offering to be offered by the employer to one or more of the full-time employees (such as one that is deemed to be compliant based on the analysis performed by the compliance engine 101) and removing a benefit offering.

In embodiments, the recommendation can include a recommended length of the first time period, such that the first time period is of a recommended length to maximize the chances of compliance. This recommendation can be determined by the compliance engine 101 based on the hours worked attributes of the employee report objects 108 on a monthly basis as well as projected hours worked, and can be used to specifically include or avoid the inclusion of abnormal periods of unusual high or low employee work activity into the analysis. For example, if in a particular month the employer is closed for remodeling and thus no employees work any hours, the employer may want to include that period into the analysis. Conversely, if an unusual event occurs that produces a sudden spike in employee hours worked such that employees that typically would not get close to full-time employee status may achieve it in that unusual month, the recommended length can be used to exclude the “spike” month.

The recommended length can include a recommended selected retroactive start date for the first time period, and/or a recommended end date for the first time period, which allow for the selection of the first time period length to account for particular events or times of the year of particularly high or low employee activity.

Depending on the rules, regulations, laws and policies associated with employer-provided benefit offerings, a modification to the first time period as described above can be restricted. As such, compliance engine 101 can be configured to generate recommendations to modify the first time period to the extent permitted applicable rules, regulations, laws, policies, etc.

In embodiments, a second time period occurs after the first time period. This second time period can correspond to a stability period, such that the employee classification at the end of the first time period remains in place for the employee for the duration of the second period regardless of the hours that the employee actually works during the second time period. Thus, in addition to a recommended length of the first time period, the recommendation can include a recommended length for a second time period which begins after the ending of the first time period. The second time period can begin immediately upon the expiration of the first time period or a time after the expiration of the first time period, as permitted by rules, regulations, laws, policies, etc.

In implementations of the inventive subject matter to the ESR provisions of the ACA, the establishment of a length or duration of the second time period is subject to conditions based on a particular employee's status as full-time or non-full time. As such, the recommendation generated by the compliance engine 101 can include a recommendation of a first length for the second time period applicable to full-time employees and a second length of the second time period for the non-full time employees.

In embodiments, the compliance engine 101 can compare one or more of the scenarios from step 130 with the effect of simply doing nothing and remaining non-compliant. For example, the cost of remaining non-compliant and paying associated penalties may be less than the cost of taking actions such as reducing one or more employee's hours or changing benefit plan offerings. In these cases, the recommendation can include a recommendation to remain non-compliant and to pay the corresponding penalties.

In embodiments, the recommendation can include details on the analysis conducted that led to the projected compliance status. The details can include a breakdown of each employee and their projected attributes, the employer strategy attributes and the benefit offering attributes that factored into the projected status determination. This detailed view of the factors going into the analysis can be included in reporting functions or recommendations presented to a user. In embodiments where multiple projected compliance statuses were generated, the recommendation can include a recommendation corresponding to the “primary” compliance status and recommendations corresponding to the secondary projected compliance statuses.

At step 150, the recommendation can be presented to a user, such as via a computing device having access to the system capable of receiving the recommendation and presenting it to the user.

An employer can have employees that qualify as full-time employees as well as employees that do not qualify as full-time employees. Under certain regulations, such as the ESR provisions of the ACA, an employer's compliance with benefit offering requirements can be affected by its non-full-time employees.

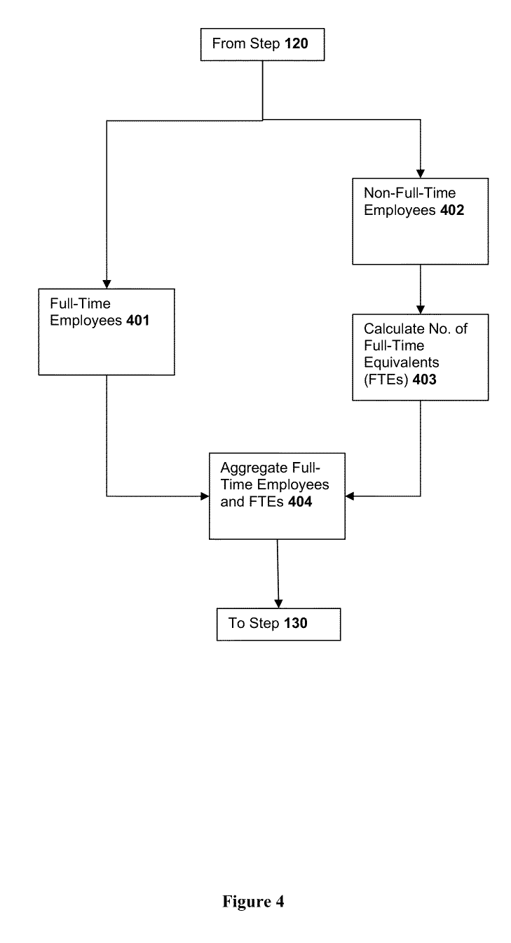

As such, the compliance engine 101 can be configured to consider an employer's non-full-time employees into the determination of a projected compliance status, as illustrated in FIG. 4.

After the compliance engine 101 conducts the analysis on a plurality of employees at step 120, the compliance engine 101 can project one or more of the company's employees as falling under the non-full-time employee classification at the end of the first time period, grouped at 302. If, as a result of the analysis in step 120, the employer also has one or more employees that are projected to be classified as full-time employees, those can be aggregated as a group of full-time employees 401.

For these employees projected to be classified as non-full-time employees 402, the compliance engine 101 proceeds to calculate a projected number of full-time employee equivalents (FTEs) at step 403. The projected number of FTEs can be considered to be the projected number of full-time employees required to perform the amount of work of the non-full-time employees, as projected to the end of the first time period.

The compliance engine 101 can calculate the projected number of FTEs as a function of the number of employees classified according to the non-full-time employee classification and projected aggregated number of total hours worked for all the projected non-full-time employees. The projected aggregated number of total hours worked is the total of the aggregated number of total hours worked for all projected non-full-time employees (reflected in the employee report objects 108 for each employee) and a projected aggregated number of total hours worked until the end of the first time period for all projected non-full-time employees. The projected number of hours worked for the non-full-time employees can be calculated using the techniques described above for the individual projected full-time employees.

Having the projected number of FTEs, the compliance engine 101 can then determine the projected employer compliance status as a function of the employees previously classified as full-time-employees 401 and the FTEs determined at 403, as well as the one or more employee benefit offering objects. The determinations of projected employer compliance statuses that account for both projected full-time employees and projected FTEs can be performed using the methods described above for step 130 of FIGS. 1 and 3.

Having determined the projected employer compliance, the compliance engine 101 can generate the recommendation as a function of the projected employer compliance status and one or more employer strategy objects as described above in step 140. For FTEs, recommended actions can include adjusting the future hours worked for one or more of the non-full-time employees through the end of the first time period.

In embodiments, the compliance engine 101 can, instead of generating a recommendation, generate a control signal transmitted to one or more of an organization's calendaring or scheduling system, payroll system and benefits management system that causes an adjustment according to an optimal solution as described above. For example, the control signal can be that causes the scheduling system to modify the hours of one or more employee so as to reduce the projected number of full-time employees or full-time equivalents while remaining within an acceptable range of one or more of the attributes of the employer's strategy object. This acceptable range can be pre-determined by the employer, or can be calculated by determining the cost of non-compliance and/or the cost of becoming compliant (such as by increasing the available benefit options and/or providing a raise to their employee) and determining the cost to the employer to miss their projections (e.g., sales or revenue projections) and then setting the range as the point where the cost of non-compliance/becoming compliant is equal to the revenue/cost of the percentage of the goal met (that is less than the full completion of the goal).

As noted above, the various steps of the system can be periodically repeated to account for updated employee information and employer strategy information. As such, the control signal can be transmitted by the compliance engine 101 periodically in response to the updated execution of the process, such that the corrections within the employer's systems are based on the most up-to-date data possible.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for ensuring benefits compliance, comprising:
an employee report database storing at least one employee report object for each employee among a plurality of employees, each of the at least one employee report object comprises report attributes, wherein the report object corresponds to at least one past reporting time period within a first time period;
an employer strategy database storing:
at least one employer strategy object comprising at least one strategy attribute, wherein each of the at least one employer strategy object corresponds to a strategy associated with an employer; and
at least one employee benefits offering object comprising offering attributes, wherein each of the at least one employee benefits offering object corresponds to an employee benefit offering provided by the employer;
a compliance engine communicatively coupled to the employee report database and the employer strategy database, the compliance engine configured to:
receive, during the first time period, employee report information for an employee, the employee report information comprising report attributes corresponding to a most recent reporting period;
generate a projected employee classification for the end of the first time period as a function of the employer strategy object, the received employee report information for the employee, and the employee report object for the employee;
determine a projected employer compliance status as a function of the projected employee classification and the employee benefit offering object; and
generate a recommendation as a function of the projected employer compliance status and at least one employer strategy object.

2. The system of claim 1, wherein the report attributes include an employee identifier, an hours worked attribute representative of the total amount of hours worked for a particular reporting time period by the employee, and at least one of an employee job attribute, an employee position attribute, an employee standing attribute, an employee wage, an employee cost, and an employee return on investment.

3. The system of claim 1, wherein the at least one strategy attribute comprises at least one of a business goal attribute, an earnings goal attribute, a progress goal attribute, a production goal attribute, an income goal attribute, an expenses goal attribute, an employer structure goal attribute, a projected business needs attribute, and a projected employment needs attribute.

4. The system of claim 1, wherein the recommendation comprises a recommended schedule for the employee for the remainder of the first time period.

5. The system of claim 1, wherein the recommendation includes a recommended length of the first time period.

6. The system of claim 5, wherein the recommended length of the first time period includes a recommended selected retroactive start date of the first time period.

7. The system of claim 5, wherein the recommended length of the first time period includes a recommended selected end date for the first time period.

8. The system of claim 5, wherein the recommendation includes a recommended length of a second time period, wherein the second time period begins upon the ending of the first time period.

9. The system of claim 1, wherein the recommendation includes a recommended adjustment to the benefit offerings represented by the offering object.

10. The system of claim 1, wherein the compliance engine configured to determine the projected employer compliance status comprises the compliance engine further configured to:
generate a projected status for the employer of compliant or non-compliant as a function of the projected employee classification and the employee benefit offering;
calculate, for a non-compliant status, a cost of non-compliance;
generate, for a non-compliant status, the recommendation as a function of the employer strategy object and the calculated cost of non-compliance.

11. The system of claim 10, wherein the cost of non-compliance comprises at least one of a cost to bring the employer into compliance and a non-compliance penalty.

12. The system of claim 1, wherein the projected employee classification comprises a classification of an employee according to a first employee classification or a second employee classification.

13. The system of claim 12, wherein the first employee classification corresponds to a full-time employee classification and the second employee classification corresponds to a non-full-time employee classification.

14. The system of claim 13, wherein the compliance engine is configured to:
calculate a projected number of employee equivalents based on one or more employees classified according the second employee classification;
determine a projected employer compliance status as a function of the employees classified according to the first employee classification, the projected number of employee equivalents, and the employee offering; and
generate a recommendation as a function of the projected employer compliance status and the at least one employer strategy.

15. The system of claim 14, wherein the compliance engine is configured to calculate the projected number of employee equivalents as a function of the number of employees classified according the second employee classification and an aggregated total amount of hours worked by the employees classified according to the second employee classification.

16. The system of claim 1, wherein the employee report database is further configured to update the employee report object based on the report attributes of the received employee report information.
